(19) United States
(12) Patent Application Publication
(10) Pub. No.: US 2006/0005038 A1
(43) Pub. Date: Jan. 5, 2006

(54) Image forming apparatus, controlling method for image forming apparatus, control program for image forming apparatus and storage medium storing program therein

(75) Inventors: Toshihiko Kitahara, Koto-ku (JP); Ikuo Takeuchi, Toride-shi (JP); Takahiro Ushiro, Toride-shi (JP); Norifumi Miyake, Kashiwa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/165,509

(22) Filed: Jun. 24, 2005

(30) Foreign Application Priority Data
Jul. 1, 2004 (JP) 2004-195760

(51) Int. Cl. H04K 1/00

(52) U.S. Cl. 713/182

(57) ABSTRACT

An image forming apparatus communicated across a network to a server for effecting personal authentication, including: a personal authentication data inputting device for inputting personal authentication data; a personal authentication data transmitting device for transmitting to the server the personal authentication data inputted by the authentication data inputting device; an authentication result receiving device for receiving a result of authentication from the server; a utilization mode data obtaining device for obtaining from the server utilization mode data corresponding to a user authenticated by the server; an operation mode setting device for setting the operation mode of the image forming apparatus to an operation mode corresponding to the utilization mode data obtained by the utilization mode data obtaining device; and a utilization mode data renewing device for renewing the utilization mode data of the server on the basis of the utilization mode data corresponding to the operation mode utilized by the user.

### BACKGROUND OF THE INVENTION

1. Field of the Invention

The invention relates to an image forming apparatus and a controlling method therefor, and a program and a storage medium, and particularly to an image forming apparatus connected to a server through a network and a controlling method therefor, and a program and a storage medium.

2. Description of the Related Art

In recent years, some of image forming apparatuses installed in stores such as print shops and convenience stores effect not only a copy service, but are connected to information processing apparatuses in the stores and individual homes and offices through a network and effect the print service of effecting print by inputs from these information processing apparatuses, and effect the service of transmitting and receiving various kinds of information through the network. As shown, for example, in Japanese Patent Application Laid-open No. 2002-278868 and Japanese Patent Application Laid-open No. 2002-99658, there has been proposed an image forming apparatus which provides a user with various services such as information terminal services capable of making ticket buying reservations and the like.

The above-described image forming apparatus is provided with a display portion for displaying various kinds of information, and an operating portion for inputting the various kinds of information, and the user performs an operation by the operating portion while confirming the display portion to thereby utilize various services.

However, the above-described image forming apparatuses installed in stores such as print shops and convenience stores differ in the type of machine from one store to another in which they are installed, and sometimes differ in the displaying method of the display portion or the operating method of the operating portion, and in that case, the user cannot easily utilize the image forming apparatuses.

Also, when the image forming apparatus effects not only a copy service but also a print service and an information terminal service, there are many operations to be performed by the use of the operating portion in order that the user may set a service required by him, and the operations are complicated.

### SUMMARY OF THE INVENTION

So, it is an object of the present invention to provide an image forming apparatus which facilitates operation and improves serviceability, irrespective of the type of the image forming apparatus and a controlling method therefor, and a program and a storage medium.

To achieve the above object, an image forming apparatus according to the present invention is an image forming apparatus connected to a server for effecting personal authentication through a network, comprising:
a personal authentication data inputting device for inputting personal authentication data;
a personal authentication data transmitting device for transmitting to the server the personal authentication data inputted by the personal authentication data inputting device;
an authentication result receiving device for receiving a result of authentication from the server;
a utilization mode data obtaining device for obtaining from the server utilization mode data corresponding to a user authenticated by the server;
an operation mode setting device for setting the operation mode of the image forming apparatus to an operation mode corresponding to the utilization mode data obtained by the utilization mode data obtaining device; and
a utilization mode data renewing device for renewing the utilization mode data of the server on the basis of the utilization mode data corresponding to the operation mode utilized by a user.

Also, a controlling method for an image forming apparatus according to the present invention is a controlling method for an image forming apparatus connected to a server for effecting personal authentication through a network, comprising:
a personal authentication data inputting step of inputting personal authentication data;
a personal authentication data transmitting step of transmitting to the server the personal authentication data inputted at the personal authentication data inputting step;
an authentication result receiving step of receiving a result of authentication for the server;
a utilization mode data obtaining step of obtaining from the server utilization mode data corresponding to a user authenticated by the server;
an operation mode setting step of setting the operation mode of the image forming apparatus to an operation mode corresponding to the utilization mode data obtained at the utilization mode data obtaining step; and
a utilization mode data renewing step of renewing the utilization mode data of the server on the basis of the utilization mode data corresponding to the operation mode utilized by the user.

Also, a control program for an image forming apparatus according to the present invention is a control program for an image forming apparatus connected to a server for effecting personal authentication through a network, comprising:
a personal authentication data inputting module for inputting personal authentication data;
a personal authentication data transmitting module for transmitting to the server the personal authentication data inputted by the personal authentication data inputting module; an authentication result receiving module for receiving a result of authentication from the server;
a utilization mode data obtaining module for obtaining from the server utilization mode data corresponding to a user authenticated by the server;
an operation mode setting module for setting the operation mode of the image forming apparatus to an operation mode corresponding to the utilization mode data obtained by the utilization mode data obtaining module; and
a utilization mode data renewing module for renewing the utilization mode data of the server on the basis of the utilization mode data corresponding to the operation mode utilized by the user.

Further, a storage medium according to the present invention is a computer-readable storage medium storing the above-described program therein.

Other objects and features of the present invention will become apparent from the following description and the accompanying drawings.

### BRIEF DESCRIPTION OF THE DRAWINGS

FIG. 1 which is comprised of FIGS. 1A and 1B schematically shows the construction of an information processing system including an image forming apparatus according to an embodiment of the present invention.

FIG. 2 is a flow chart of an operation mode changing process executed by the image forming apparatus 1 of FIGS. 1A and 1B.

FIG. 3 is a flow chart of a first modification of the operation mode changing process of FIG. 2.

FIG. 4 is a flow chart of a second modification of the operation mode changing process of FIG. 2.

FIG. 5 is a flow chart of a third modification of the operation mode changing process of FIG. 2.

FIG. 6 is a flow chart of a fourth modification of the operation mode changing process of FIG. 2.

### DESCRIPTION OF THE PREFERRED EMBODIMENTS

Some embodiments of the present invention will hereinafter be described in detail with reference to the drawings.

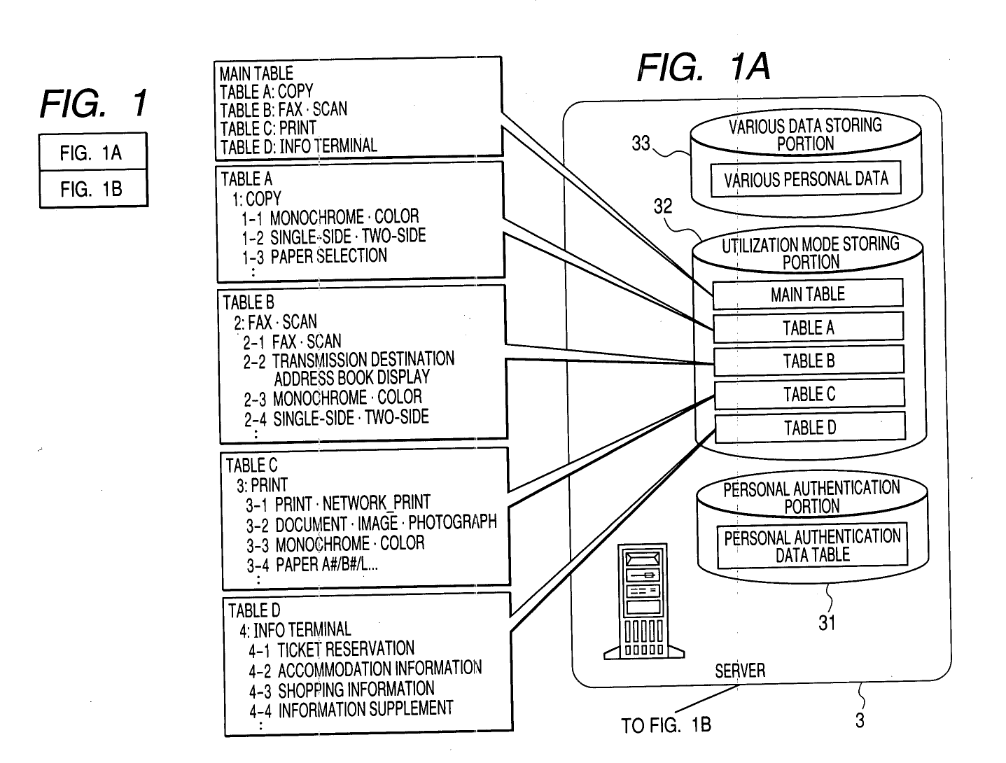

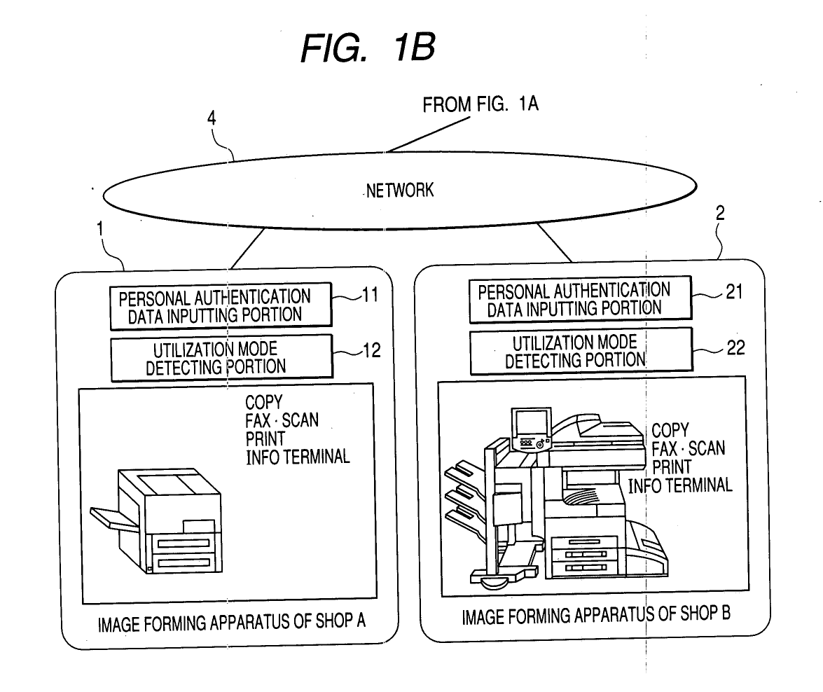

FIGS. 1A and 1B schematically show the construction of an information processing system including an image forming apparatus according to an embodiment of the present invention.

The information processing system of FIGS. 1A and 1B comprises the image forming apparatus 1 of a store A installed in the store A, the image forming apparatus 2 of a store B installed in the store B, and a server 3, and these are connected together through a network 4 and are capable of transmitting and receiving data among them.

Each of the image forming apparatus 1 of the store A and the image forming apparatus 2 of the store B is a compound machine providing a copy service, a printing machine service, a fax/scan service and an information terminal service. A user, when he utilizes, for example, the copy services of the image forming apparatuses 1 and 2, selects a desired operation mode from among such operation modes as monochrome copy/color copy, single-sided copy/two-sided copy, etc.

The image forming apparatus 1 of the store A has a personal authentication data inputting portion 11 for inputting user authentication information such as user ID for authenticating the user, and a utilization mode detecting portion 12 for periodically detecting an operation mode selected by the user, and holding the information of the detected operation mode (hereinafter referred to as the “utilization mode data”).

The image forming apparatus 2 of the store B has a personal authentication data inputting portion 21 and a utilization mode detecting portion 22, and these are functionally similar to the personal authentication data inputting portion 11 and the utilization mode detecting portion 12.

Here, the inputting of personal authentication data in the personal authentication data inputting portions 11 and 12 is effected by the user inputting them from an operating portion. The user may insert an ID card storing the personal authentication data therein into the image forming apparatus, and the personal authentication data may be read from the ID card.

The server 3 has a personal authentication data table storing registered personal authentication data therein, and a personal authentication portion 31 for obtaining the personal authentication data inputted by the personal authentication data inputting portions 11 and 21 of the image forming apparatuses 1 and 2, and effecting the authentication of the user with reference to a personal authentication data table. Also, the server 3 has a utilization mode storing portion 32 for relating and storing therein utilization mode data and user information held in the utilization mode detecting portions 12 and 22, and a various data storing portion 33 for storing various personal data, etc. therein.

The utilization mode storing portion 32 has a main table and tables A-D.

The main table has information on a service to be applied, and a table storing therein utilization mode data corresponding to the service. Specifically, a copy service is the table A, a fax service and a scan service are the table B, a print service is the table C, and a various information terminal service is the table D.

The table A comprises the utilization mode data of the copy service (such as monochrome copy/color copy, and single-sided copy/two-sided copy). The table B comprises the utilization mode data of the fax/scan service (such as the presence or absence of the display of an address book of fax transmitters, and monochrome/color). The table C comprises the utilization mode data of the print service (such as the printing of print data brought in by the user, and the printing of photographs from a digital camera or the like). The table D comprises the utilization mode data of the information terminal service (such as ticket reservation, lodging information and the outputting of shopping information at stores such as various supermarkets).

The above-described various tables are examples and correspond to the contents of services provided by and the operation modes of the image forming apparatuses of the print shops and convenience stores, and by using encoded common data corresponding to code data mutually related for the content of each service, it is possible to control the utilization mode data without depending on functions inherent to the respective image forming apparatuses.

The utilization mode data preserved in the utilization mode storing portion 32 of the server 3 can also be read and preserved from any image forming apparatus if they are authenticated by the personal authentication portion 31.

The information processing system of FIGS. 1A and 1B operates as follows.

When the image forming apparatus 1 of the store A is to be utilized, if the user inputs personal authentication data by the use of the personal authentication data inputting portion 11, the inputted personal authentication data is transmitted to the server 3 through the network 4. The personal authentication portion 31 of the server 3, when it authenticates that the user is a user registered in advance by the transmitted personal authentication data, transmits the result of the authentication to the image forming apparatus 1 of the store A through the network 4. Thereby, the authenticated user becomes able to utilize the image forming apparatus 1.

At this time, the image forming apparatus 1 loads utilization mode data corresponding to the authenticated user from the utilization mode storing portion 32, and operates in an operation mode corresponding to the utilization mode data. When the user utilizes the present information processing system for the first time, the utilization mode data is not stored in the utilization mode storing portion 32 and therefore, the image forming apparatus 1 operates in a preset default operation mode.

The user selects various services by the image forming apparatus 1, and performs various operations to thereby utilize the selected services. The image forming apparatus 1 of the store A detects the operation mode utilized by the user and holds it as utilization mode data by the utilization mode detecting portion 12 during the time from after the user starts the utilization until he finishes it, and periodically transmits it to the utilization mode storing portion 32 of the server 3 through the network 4. The transmission of the utilization mode data is effected each time the user changes over the function or at each predetermined time. The utilization mode storing portion 32 relates the transmitted utilization mode data to the user and stores it therein.

When the user utilizes the image forming apparatus 1 of the store A next time, he transmits the personal authentication information to the server 3 as he did the last time, and when the personal authentication portion 31 of the server 3 authenticates that the user is a pre-registered user, the authenticated user becomes able to utilize the image forming apparatus 1. At this time, the server 3 authenticates the user and simultaneously therewith, refers to the utilization mode storing portion 32 of the server 3 to thereby refer to the utilization mode data when the user utilized the last time and transmits the utilization mode data to the image forming apparatus 1 through the network 4.

In the image forming apparatus 1 of the store A, a utilization mode is selected and displayed in accordance with the utilization mode data read out from the utilization mode storing portion 32 of the server 3. In this case, as a method of determining the utilization mode with reference to the utilization mode data stored in the utilization mode storing portion 32 of the server 3, the operation mode when the utilization was finished the last time may be displayed, or an operation mode often utilized by plural times of utilization may be displayed, or plural operation modes of operation modes often utilized by plural times of utilization which are great in the frequency of utilization may be displayed.

When the user utilizes the image forming apparatus for the first time, or when the utilization mode data is not stored in the utilization mode storing portion 32 of the server 3, or when the loaded utilization mode data is not of a value within a preset range, a preset initial screen is displayed on the image forming apparatus.

The utilization mode data stored in the aforedescribed utilization mode storing portion 32 correspond to various items the tables A-D in the same utilization mode storing portion 32 have, and for example, when the user has printed the photographic data of a digital camera, and by the main table in the utilization mode storing portion 32 of the server 3, it is judged that the table corresponding to the print service is the table C, and in the table C, there are stored values obtained by condition selection for the service items of the printing function, e.g. items 3-1 to 3-4 in the table C in FIGS. 1A and 1B, having been effected. When the print service is used next time, it is judged to be a photographic print from the utilization mode data stored in the utilization mode storing portion 32, and the operation mode can be changed.

Also, for example, when the image forming apparatus 1 of the store A has been utilized before the image forming apparatus 2 of the store B is utilized, the utilization mode data utilized in the image forming apparatus 1 of the store A can be loaded from the utilization mode storing portion 32 of the server 3 to the image forming apparatus 2, and the same operation environment can be obtained even in a different image forming apparatus or an image forming apparatus installed in a different store.

Also, in some image forming apparatuses, there is a case where even if utilization mode data utilized by the user is introduced from the utilization mode storing portion 32 of the server 3, a service corresponding to the utilization mode data cannot be effected, but in such case, the display that the service cannot be effected may be effected to the user and also, a service more significant than the service corresponding to the utilization mode data may be displayed, or an initial screen set by the image forming apparatus may be displayed.

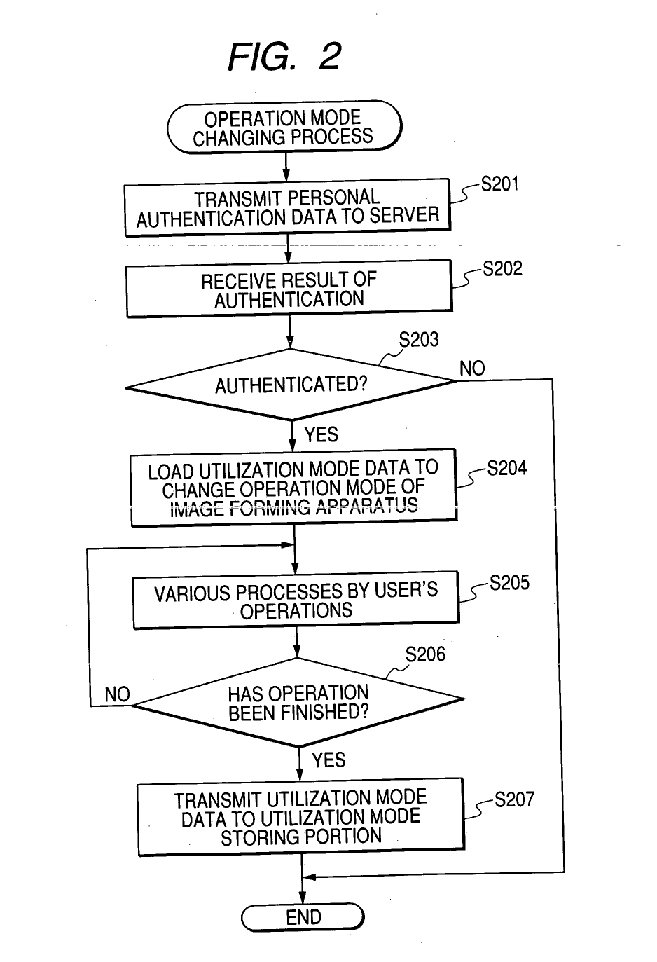

FIG. 2 is a flow chart of an operation mode changing process executed by the image forming apparatus 1 of FIGS. 1A and 1B.

In FIG. 2, when operating the image forming apparatus 1, the personal authentication data inputting portion 11 of the image forming apparatus 1 first transmits personal authentication data inputted by the user to the server 3 through the network 4 (step S201). Next, the image forming apparatus 1 receives the result of the authentication of the personal authentication data done by the personal authentication portion 31 of the server 3 (step S202). Then, the image forming apparatus 1 discriminates whether the personal authentication data has been authenticated in the server 3 (step S203), and when the personal authentication data is not authenticated in the server 3 as in a case where wrong personal authentication data has been inputted, the present process is finished.

When as a result of the discrimination at the step S203, the personal authentication data has been authenticated in the server 3, utilization mode data is loaded from the utilization mode storing portion 32 of the server 3, and an operation mode corresponding to the utilization mode data is determined by referring to a table in the utilization mode storing portion 32 of the server 3, thereby changing the operation mode of the image forming apparatus 1 (step S204). Then, the authenticated user selects the operation mode and operates the image forming apparatus 1, whereby the image forming apparatus 1 executes various processes such as copying, printing, fax/scan and a process as an information terminal (step S205).

Then, the authenticated user gives finishing instructions from the operation finishing key of the image forming apparatus 1 and discriminates whether the operation is finished (step S206), and if the operation is not finished, return is made to the step S205. On the other hand, if the operation is finished, the utilization mode detecting portion 12 of the image forming apparatus 1 transmits the so far utilized utilization mode data to the utilization mode storing portion 32 of the server 3 and renews the utilization mode data (step S207). Thereafter, the present process is finished.

According to the process of FIG. 2, utilization mode data is loaded from the utilization mode storing portion 32 of the server 3 and an operation mode corresponding to the utilization mode data is determined by referring to the table in the utilization mode storing portion 32 of the server 3, and the operation mode of the image forming apparatus 1 is changed (step S204) and therefore, irrespective of the type of the image forming apparatus, the service utilized the last time can be utilized with an easy operation.

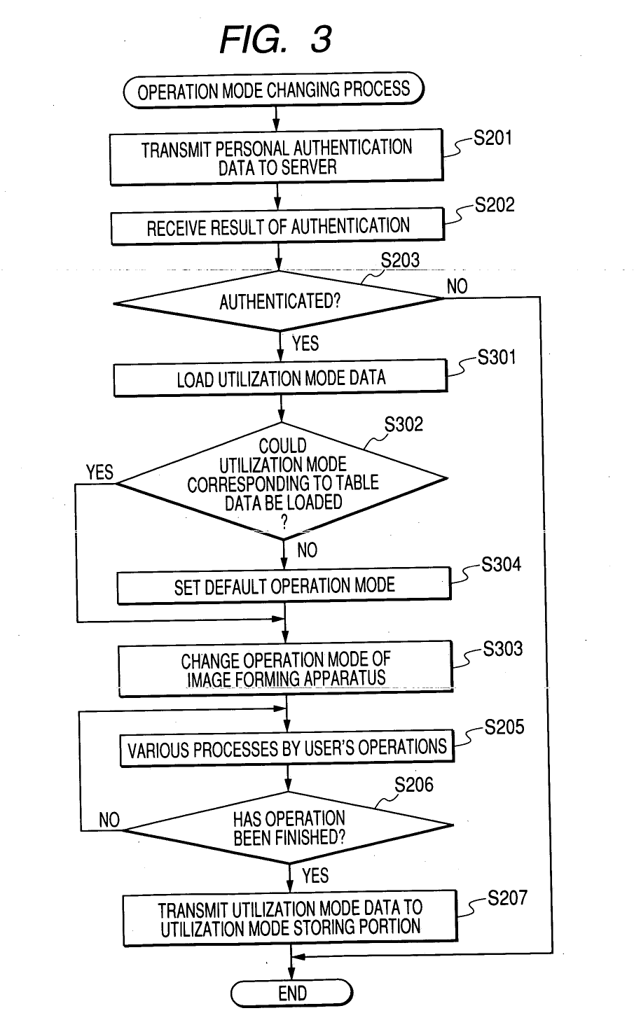

FIG. 3 is a flow chart of a first modification of the operation mode changing process of FIG. 2.

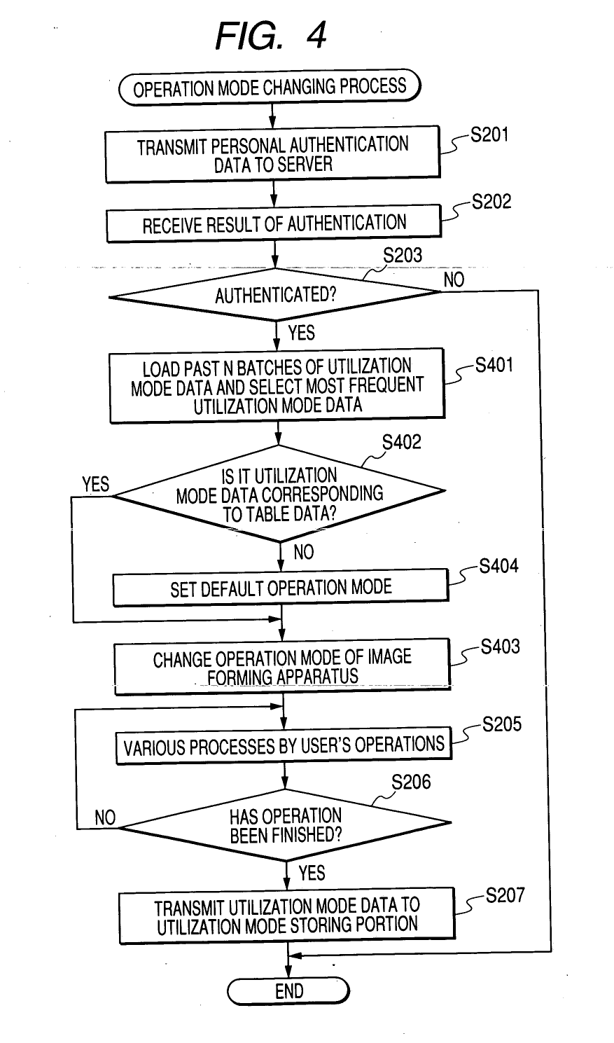

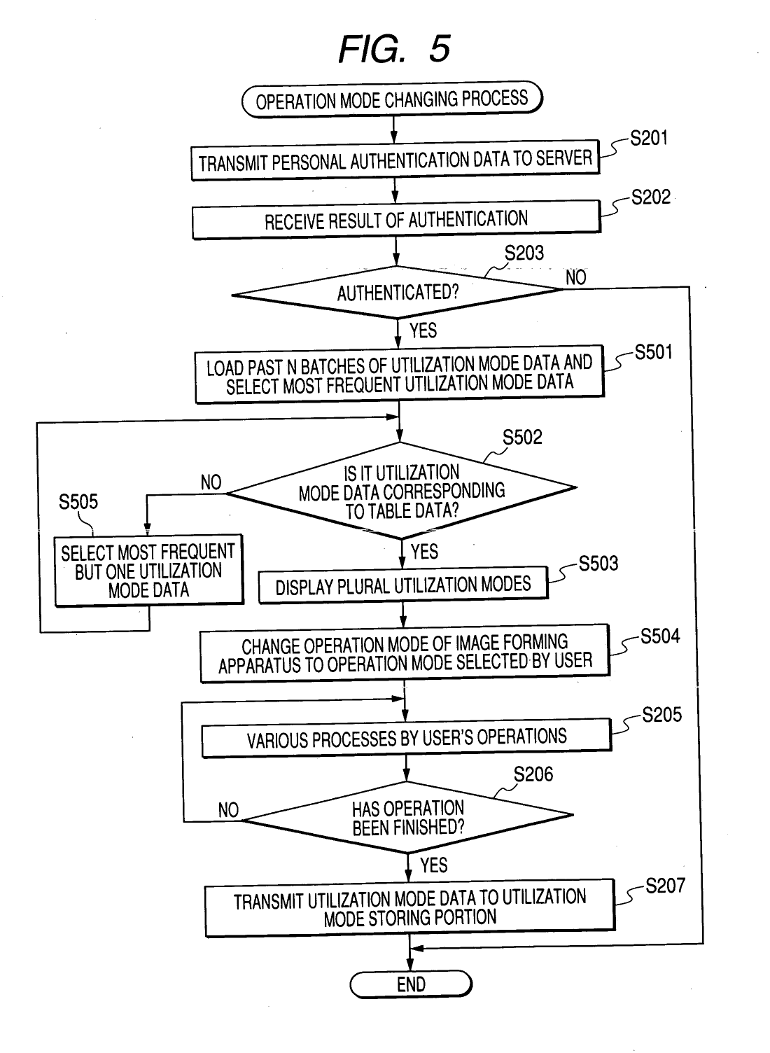

This process is a process in a case where the utilization mode data is not stored in the utilization mode storing portion 32 of the server 3. This process is basically the same as the process of FIG. 2, and differs from the process of FIG. 2 only in that steps S301 to S304 are provided instead of the step S204. The same step as the steps of FIG. 2 are given the same reference characters and need not be described, and only the portions differing from the process of FIG. 2 will be described below. This also holds true of the processes of FIGS. 4 and 5.

In FIG. 3, when the user is authenticated as a result of the discrimination at a step S203, utilization mode data is loaded from the utilization mode storing portion 32 of the server 3 (step S301). Next, whether utilization mode data corresponding to the table data in the utilization mode storing portion 32 of the server 3 could be loaded is discriminated (step S302). If the utilization mode data corresponding to the table data could be loaded, an operation mode corresponding to the utilization mode data is determined by referring to the table in the utilization mode storing portion 32 of the server 3, and the operation mode of the image forming apparatus 1 is changed (step S303). Thereafter, the processes of a step S205 and subsequent steps are executed, thus finishing the present process.

If as a result of the discrimination at the step S302, the utilization mode data corresponding to the table data could not be loaded, that is, could not be loaded due either to the loaded utilization mode data not corresponding to the table data or to the utilization mode data being not written in, the operation mode is set to a default operation mode preset in the image forming apparatus 1 (step S304). Thereafter, the processes of a step S303 and subsequent steps are executed, thus finishing the present process.

According to the process of FIG. 3, if the utilization mode data corresponding to the table data could not be loaded from the utilization mode storing portion 32 of the server 3 (NO at the step S302), the operation mode is set to the default operation mode preset in the image forming apparatus 1 (step S304) and therefore, even when the past utilization mode data could not be obtained as in a case where the user utilizes the service for the first time, the user can utilize the service.

FIG. 4 is a flow chart of a second modification of the operation mode changing process of FIG. 2.

This process is a process in a case where a plurality of utilization mode data are stored in the utilization mode storing portion 32 of the server 3. This process is basically the same as the process of FIG. 2, and differs from the process of FIG. 2 only in that steps S401 to S404 are provided instead of the step S204.

In FIG. 4, if as a result of the discrimination at a step S203, the user is authenticated, N batches of utilization mode data in the past are loaded from a plurality of utilization mode data utilized in the past and held in the utilization mode storing portion 32 of the server 3, and the utilization mode data greatest in the frequency of utilization is selected from among N batches of loaded utilization mode data (step S401).

Next, whether the selected utilization mode data is utilization mode data corresponding to the table data in the utilization mode storing portion 32 of the server 3 is discriminated (step S402). If the selected utilization mode data is utilization mode data corresponding to the table data, an operation mode corresponding to the utilization mode data is determined by referring to the table in the utilization mode storing portion 32 of the server 3, and the operation mode of the image forming apparatus 1 is changed (step S403). Thereafter, the processes of a step S205 and subsequent steps are executed, thus finishing the present process.

If as a result of the discrimination at the step S402, the selected utilization mode data is not utilization mode data corresponding to the table data, that is, the utilization mode data corresponding to the table data could not be loaded due either to the selected utilization mode data not corresponding to the table data, or to the utilization mode data being not written in, the operation mode is set to a default operation mode preset in the image forming apparatus 1 (step S404). Thereafter, the processes of the step S403 and subsequent steps are executed, thus finishing the present process.

According to the process of FIG. 4, the utilization mode data greatest in the frequency of utilization is selected from among N batches of utilization mode data loaded from a plurality of utilization mode data utilized in the past and held in the utilization mode storing portion 32 of the server 3 (step S401) and therefore, irrespective of the type of the image forming apparatus, a service great in the frequency of utilization can be utilized with an easy operation.

FIG. 5 is a flow chart of a third modification of the operation mode changing process of FIG. 2.

This process is a process in a case where a plurality of utilization mode data are stored in the utilization mode storing portion 32 of the server 3. In the process of FIG. 4, the utilization mode data highest in the frequency of utilization has been selected from among a plurality of utilization mode data, but in the present process, display is effected so that the user can select utilization mode data from among a plurality of utilization mode data high in the frequency of utilization.

The present process is basically the same as the process of FIG. 2, and differs from the process of FIG. 2 only in that steps S501 to S505 are provided instead of the step S204.

In FIG. 5, if as a result of the discrimination at the step S203, the user is authenticated, N batches of utilization mode data in the past are loaded from a plurality of utilization mode data utilized in the past and held in the utilization mode storing portion 32 of the server 3, and M batches of utilization mode data great in the frequency of utilization are selected from among N batches of loaded utilization mode data (step S501).

Next, whether the selected M batches of utilization mode data are data corresponding to the table data in the utilization mode storing portion 32 of the server 3 is discriminated (step S502). If the selected M batches of utilization mode data are utilization mode data corresponding to the table data, a plurality of operation modes corresponding to the selected M batches of utilization mode data are displayed on the display portion of the image forming apparatus 1 (step S503).

Next, when the user selects one operation mode from among the plurality of displayed operation modes, the operation mode of the image forming apparatus 1 is changed to the selected operation mode (step S504). Thereafter, the processes of a step S205 and subsequent steps are executed, thus finishing the present process.

If as a result of the discrimination at the step S502, the selected utilization mode data is not the utilization mode data corresponding to the table data, that is, the utilization mode data corresponding to the table data could not be loaded due either to the selected utilization mode data not corresponding to the table data, or to the utilization mode data being not written in, the utilization mode data not corresponding to the table data is deleted and the utilization mode data second highest in the frequency of utilization is selected (step S505). Thereafter, return is made to the step S502.

According to the process of FIG. 5, a plurality of operation modes corresponding to M batches of utilization mode data great in the frequency of utilization are displayed on the display portion of the image forming apparatus 1 (step S503), and when the user selects one operation mode from among the plurality of displayed operation modes, the operation mode of the image forming apparatus 1 is changed to the selected operation mode (step S504) and therefore, irrespective of the type of the image forming apparatus, a service great in the frequency of utilization can be utilized with an easy operation.

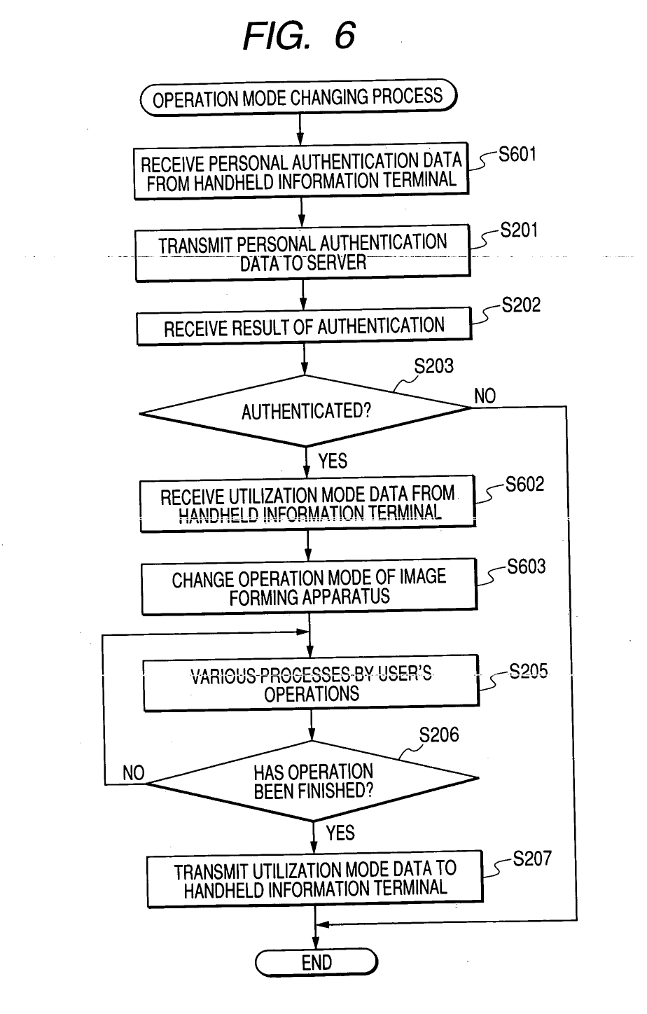

FIG. 6 is a flow chart of a fourth modification of the operation mode changing process of FIG. 2.

This process is a process in a case where a handheld information terminal possessed by the user is used as the inputting method of the personal authentication data inputting portion 11 in the image forming apparatus 1. In the processes of FIGS. 2 to 5, the inputting method of the personal authentication data inputting portion 11 is carried out by an input from the operating portion or inserting an ID card, but in the present process, it is carried out by transmitting personal authentication data from the handheld information terminal.

The present process is basically the same as the process of FIG. 2, and differs from the process of FIG. 2 only in that it has a step S601 and that a step S602 and a step S603 are provided instead of the step S204.

In FIG. 6, personal authentication data transmitted from the handheld information terminal possessed by the user is first received (step S601). Then, the personal authentication data inputting portion 11 of the image forming apparatus 1 transmits the received personal authentication data to the server 3 through the network 4 (step S201). Next, the result of the authentication of the personal authentication data done by the personal authentication portion 31 of the server 3 is received (step S202).

The image forming apparatus 1 discriminates whether the personal authentication data has been authenticated in the server 3 (step S203), and if the personal authentication data is not authenticated in the server 3 as in a case when wrong personal authentication data has been inputted, the present process is finished.

If as a result of the discrimination at the step S203, the personal authentication data is authenticated in the server 3, utilization mode data is received from the handheld information terminal (step S602). Then, on the basis of the received utilization mode data, the operation mode of the image forming apparatus 1 is changed (step S603). Thereafter, the authenticated user selects an operation mode and operates the image forming apparatus 1, whereby the image forming apparatus 1 executes various processes such as copying, printing, fax and scanning, and a process as an information terminal (step S205). The processes thereafter are similar to those shown in FIG. 2 and need not be described.

According to the process of FIG. 6, it is not necessary to secure in the server 3 a storing area for storing the utilization mode data therein, nor it is necessary for the server 3 to transmit the utilization mode data and therefore, the load applied to the server 3 can be reduced and also, even if the specification of the server 3 is low, the system according to the present embodiment can be constructed.

While in FIGS. 2 to 6, the process executed by the image forming apparatus 1 of the store A has been described as an example, the image forming apparatus 2 of the store B can also execute a similar process. Also, for example, when the image forming apparatus 1 of the store A is utilized before the image forming apparatus 2 of the store B is utilized, the utilization mode data utilized in the image forming apparatus 1 of the store A can be loaded from the utilization mode storing portion 32 of the server 3 to the image forming apparatus 2, and the same operation environment can also be obtained in a different image forming apparatus or an image forming apparatus installed in a different store.

Also, of course, the objects of the present invention are achieved by supplying a system or an apparatus with a storage medium having recorded therein the program code of soft ware realizing the functions of the above-described embodiments, and the computer (or CPU or MPU) of the system or the apparatus reading out and executing the program code stored in the storage medium.

In this case, the program code itself read out from the storage medium realizes the functions of the aforedescribed embodiments, and the program code and the storage medium storing the program therein constitute the present invention.

Also, of course, not only the functions of the aforedescribed embodiments are realized by the program code read out by the computer being executed, but also there is covered a case where on the basis of the instructions of the program code, an operating system (OS) or the like working on the computer performs part or the whole of an actual process, and the functions of the aforedescribed embodiments are realized by the process.

Further, of course, there is also covered a case where the program code read out from the storage medium is written into a memory provided in a function expanding card inserted in the computer or a function expanding unit connected to the computer, thereafter on the basis of the instructions of the program code, a CPU or the like provided in the function expanding card or the function expanding unit performs part or the whole of an actual process, and the functions of the aforedescribed embodiments are realized by the process.

Also, the above-described program can only realize the functions of the above-described embodiments by a computer, and the form thereof may be the form of an object code, a program code executed by an interpreter, script data supplied to OS, or the like.

The storage medium supplying the program can be one capable of storing the above-described program therein such as, for example, a Floppy (registered trademark) disc, an optical disc, a magneto-optical disc, a CD-ROM, a CD-R, a CD-RW, a DVD (DVD-ROM, DVD-RAM, DVD-RW or DVD+RW), a magnetic tape, a non-volatile memory card or other ROM. Alternatively, the above-described program is supplied by being down-loaded from other computer or a data base, not shown, connected to the Internet, a commercially available network or a local area network.

According to the embodiments described above, utilization mode data corresponding to an authenticated user is obtained from the utilization mode storing portion 32 of the server 3, and the operation mode of the image forming apparatus 1 is set to an operation mode corresponding to the obtained utilization mode data, and the utilization mode data of the utilization mode storing portion 32 is renewed on the basis of the utilization mode data corresponding to the operation mode utilized by the user and therefore, irrespective of the type of the image forming apparatus 1, the operation can be facilitated and the convenience can be improved.

Also, when the utilization mode data could not be obtained, the operation mode of the image forming apparatus 1 is set to a preset initial operation mode and therefore, even when the past utilization mode data could not be obtained as in a case where the user utilizes the service for the first time, the user can utilize the service.

Also, mode data is renewed when the user has finished the operation of the image forming apparatus 1, and the renewed utilization mode data is obtained when the user's last operation was finished and therefore, irrespective of the type of the image forming apparatus 1, the service utilized the last time can be utilized with an easy operation.

Also, a plurality of utilization mode data are obtained, and the operation mode of the image forming apparatus 1 is set to an operation mode corresponding to the utilization mode data of the plurality of obtained utilization mode data which is high in the frequency of utilization and therefore, irrespective of the type of the image forming apparatus 1, services great in the frequency of utilization can be utilized with an easy operation.

Also, of the plurality of obtained utilization mode data, a plurality of operation modes corresponding to a plurality of utilization mode data high in the frequency of utilization are displayed, and the operation mode of the image forming apparatus 1 is set to an operation mode the user has selected from among the plurality of displayed operation modes and therefore, irrespective of the type of the image forming apparatus 1, services great in the frequency of utilization can be utilized with an easy operation.

Also, one image forming apparatus obtains utilization mode data renewed by the one image forming apparatus or another image forming apparatus and therefore, even in a different image forming apparatus or an image forming apparatus installed in a different store, the same operation environment can be obtained.

This application claims priority from Japanese Patent Application No. 2004-195760 filed Jul. 1, 2004, which is hereby incorporated by reference herein.

What is claimed is:

1. An image forming apparatus communicated across a network to a server for effecting personal authentication, said image forming apparatus comprising:
a personal authentication data inputting device, which inputs personal authentication data;
a personal authentication data transmitting device, which transmits to said server the personal authentication data inputted by said personal authentication data inputting device;
an authentication result receiving device, which receives a result of authentication from said server;
a utilization mode data obtaining device, which obtains from said server utilization mode data corresponding to a user authenticated by said server;
an operation mode setting device, which sets an operation mode of said image forming apparatus to an operation mode corresponding to the utilization mode data obtained by said utilization mode data obtaining device; and
a utilization mode data renewing device, which renews the utilization mode data of said server on the basis of the utilization mode data corresponding to the operation mode utilized by the user.

2. An image forming apparatus according to claim 1, wherein when said utilization mode data obtaining device could not obtain the utilization mode data, said operation mode setting device sets the operation mode of said image forming apparatus to a preset initial operation mode.

3. An image forming apparatus according to claim 1, wherein said utilization mode data renewing device renews the utilization mode data when the user's operation of said image forming apparatus has been finished, and said utilization mode data obtaining device obtains the renewed utilization mode data when the user's last operation has been finished.

4. An image forming apparatus according to claim 1, wherein said utilization mode data obtaining device obtains a plurality of utilization mode data, and said operation mode setting device sets the operation mode of said image forming apparatus to an operation mode corresponding to the utilization mode data of the plurality of utilization mode data obtained by said utilization mode data obtaining device which is high in frequency of utilization.

5. An image forming apparatus according to claim 1, wherein said utilization mode data obtaining device obtains a plurality of utilization mode data, and said operation mode setting device displays on a display portion a plurality of operation modes corresponding to a plurality of utilization mode data of the plurality of utilization mode data obtained by said utilization mode data obtaining device which are high in frequency of utilization, and sets the operation mode of said image forming apparatus to an operation mode the user has selected from among the plurality of operation modes displayed on said display portion.

6. An image forming apparatus according to claim 1, wherein in a case where a plurality of image forming apparatuses are communicated to each other across the network, said utilization mode data obtaining device of one image forming apparatus obtains utilization mode data renewed by said utilization mode data renewing device of said one image forming apparatus or another image forming apparatus.

7. An image forming apparatus according to claim 1, wherein the personal authentication data inputting device inputs the personal authentication data by an input from an operating portion by the user.

8. An image forming apparatus according to claim 1, wherein the personal authentication data inputting device inputs the personal authentication data by an input from a handheld information terminal possessed by the user.

9. A controlling method for an image forming apparatus communicated across a network to a server for effecting personal authentication, said controlling method comprising:
a personal authentication data inputting step of inputting personal authentication data;
a personal authentication data transmitting step of transmitting to said server the personal authentication data inputted at said personal authentication data inputting step;
an authentication result receiving step of receiving a result of authentication from said server;
a utilization mode data obtaining step of obtaining from said server utilization mode data corresponding to a user authenticated by said server;
an operation mode setting step of setting an operation mode of said image forming apparatus to an operation mode corresponding to the utilization mode data obtained at said utilization mode data obtaining step; and
a utilization mode data renewing step of renewing the utilization mode data of said server on the basis of the utilization mode data corresponding to the operation mode utilized by the user.

10. A controlling method according to claim 9, wherein when the utilization mode data could not be obtained at said utilization mode data obtaining step, said operation mode setting step sets the operation mode of said image forming apparatus to a preset initial operation mode.

11. A controlling method according to claim 9, wherein said utilization mode data renewing step renews the utilization mode data when the user's operation of said image forming apparatus has been finished, and said utilization mode data obtaining step obtains the renewed utilization mode data when the user's last operation has been finished.

12. A controlling method according to claim 9, wherein said utilization mode data obtaining step obtains a plurality of utilization mode data, and said operation mode setting step sets the operation mode of said image forming apparatus to an operation mode corresponding to utilization mode data of the plurality of utilization mode data obtained at said utilization mode data obtaining step which is high in frequency of utilization.

13. A controlling method according to claim 9, wherein said utilization mode data obtaining step obtains a plurality of utilization mode data, and said operation mode setting step displays a display portion a plurality of operation modes corresponding to a plurality of utilization mode data of the plurality of utilization mode data obtained at said utilization mode data obtaining step which are high in frequency of utilization, and sets the operation mode of said image forming apparatus to an operation mode the user has selected from among the plurality of operation modes displayed on said display portion.

14. A controlling method according to claim 9, wherein in a case where a plurality of image forming apparatuses are communicated to each other across the network, said utilization mode data obtaining step or one image forming apparatus obtains the utilization mode data renewed by said utilization mode data renewing step of said one image forming apparatus or another image forming apparatus.

15. A controlling method according to claim 9, wherein the personal authentication data inputting step inputs the personal authentication data by an input from an operating portion by the user.

16. A controlling method according to claim 9, wherein said personal authentication data inputting step inputs the personal authentication data by an input from a handheld information terminal possessed by the user.

17. A control program for an image forming apparatus communicated across a network to a server for effecting personal authentication, said control program comprising:
a personal authentication data inputting module, which inputs personal authentication data;
a personal authentication data transmitting module, which transmits to said server the personal authentication data inputted by said personal authentication data inputting module;
an authentication result receiving module, which receives a result of authentication from said server;
a utilization mode data obtaining module, which obtains from said server utilization mode data corresponding to a user authenticated by said server;
an operation mode setting module, which sets the operation mode of said image forming apparatus to an operation mode corresponding to the utilization mode data obtained by said utilization mode data obtaining module; and
a utilization mode data renewing module, which renews the utilization mode data of said server on the basis of the utilization mode data corresponding to the operation mode utilized by the user.

18. A computer-readable storage medium, which stores a control program as recited in claim 17.
